(19) United States
(12) Patent Application Publication
(10) Pub. No.: US 2014/0332246 A1
(43) Pub. Date: Nov. 13, 2014

(54) DAMPER SYSTEM FOR A POWER CELL OF A HYDRAULIC HAMMER

(71) Applicant: Caterpillar Inc., Peoria, IL (US)

(72) Inventors: Cody Moore, Waco, TX (US); Jayaram Gunasekaran, Chennai (IN); Colins Jacob, Bangalore (IN); Arun Palanoor, Bangalore (IN)

(73) Assignee: Caterpillar Inc., Peoria, IL (US)

(21) Appl. No.: 14/445,153

(22) Filed: Jul. 29, 2014

(51) Int. Cl. B25D 17/24

(52) U.S. Cl. CPC B25D 17/24
USPC 173/211

(57) ABSTRACT

A damper system for a power cell includes a single-piece top damper element disposed on the power cell, a pair of middle damper elements disposed about a mid-portion of the power cell, and a single-piece bottom damper element that is formed from a material having Shore hardness in the range of about 90 A to 95 A. The middle damper elements are mutually identical in construction, and include interlocking features that are configured to allow a releasable engagement therebetween. The bottom damper element defines a central opening therein, and includes a base plate disposed about the central opening. The bottom damper element further includes appendages extending axially from a top side of the base plate, and a lateral projection extending radially inward from each of the appendages. The lateral projection is configured to abut a top side of a keel member defined at a bottom portion of the power cell.

### TECHNICAL FIELD

The present disclosure generally relates to a damper system. More particularly, the present disclosure relates to a damper system for a power cell of a hydraulic hammer

### BACKGROUND

Power hammers typically include a power cell disposed within a body. Moreover, the power hammers may employ one or more dampers disposed between the power cell and the body. For reference, U.S. Pat. No. 5,419,404 relates to a hydraulic impact hammer comprising a protective casing made of two side plates, and provided with attenuation elements for eliminating the noise and vibration caused by the impact hammer

Although the dampers are provided to attenuate noise and/or vibrations experienced during operation of the power hammers, the noise attenuation and vibration damping characteristics of the dampers may be significantly determined by several factors such as, but not limited to, a configuration of the dampers and/or a type of material used in the dampers.

Further, in forming a system of dampers for the power cell, it may be required to physically link or couple two or more dampers, or even abut the individual dampers to the body of the power hammer so that the dampers may be prevented from being displaced during an operation of the power hammer However, some of the previously known damper systems may not adequately provide mechanisms for securing the positions of the dampers within the body of the power hammer

Moreover, when a system of dampers is configured for use in power hammers, it has been observed that each damper has a distinct structure and/or shape associated thereto. Such distinct structures and/or shapes for the dampers entail increased tooling and/or manufacturing costs associated thereto. Hence, there is a need for a system that overcomes the aforementioned shortcomings

### SUMMARY OF THE DISCLOSURE

In an aspect of the present disclosure, a damper system for a power cell of a hydraulic hammer includes a single-piece top damper element, a pair of middle damper elements, and a single-piece bottom damper element. The single-piece top damper element is configured to be disposed on the power cell.

The pair of middle damper elements is disposed about a mid-portion of the power cell, wherein the pair of middle damper elements is mutually identical in construction. Moreover, each of the middle damper elements includes interlocking features at lateral ends thereof The interlocking features are configured to allow a releasable engagement of the middle damper elements.

The bottom damper element is formed from a material having Shore hardness in the range of about 90 A to 95 A. The bottom damper element defines a central opening therein. The central opening is configured to allow passage of a pecking tool therethrough. The bottom damper element includes a base plate, and a plurality of appendages. The base plate is disposed about the central opening and is configured to bear the power cell thereon. The appendages extend axially upwards from a periphery of the base plate and are disposed about the central opening. The bottom damper element further includes a lateral projection extending radially inward from each of the plurality of appendages. The lateral projection is configured to abut a top side of a keel member defined at a bottom portion of the power cell.

Other features and aspects of this disclosure will be apparent from the following description and the accompanying drawings.

### BRIEF DESCRIPTION OF THE DRAWINGS

FIG. 1 is a diagrammatic view of an exemplary machine using a hydraulic hammer in accordance with an embodiment of the present disclosure;

FIG. 2 is a diagrammatic view of the hydraulic hammer in accordance with an embodiment of the present disclosure, the diagrammatic view presenting the hydraulic hammer in an exploded configuration and a partially assembled configuration;

FIG. 3 is a sectional view of the hydraulic hammer taken along section line A-A′ of FIG. 2;

FIGS. 4a and 4b are top and bottom perspective views of a top damper element that is employed by the hydraulic hammer of FIG. 2;

FIG. 5 is a side perspective view of two middle damper elements that are employed by the hydraulic hammer of FIG. 2; and

FIG. 6 is a top perspective view of a bottom damper element that is employed by the hydraulic hammer of FIG. 2.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims.

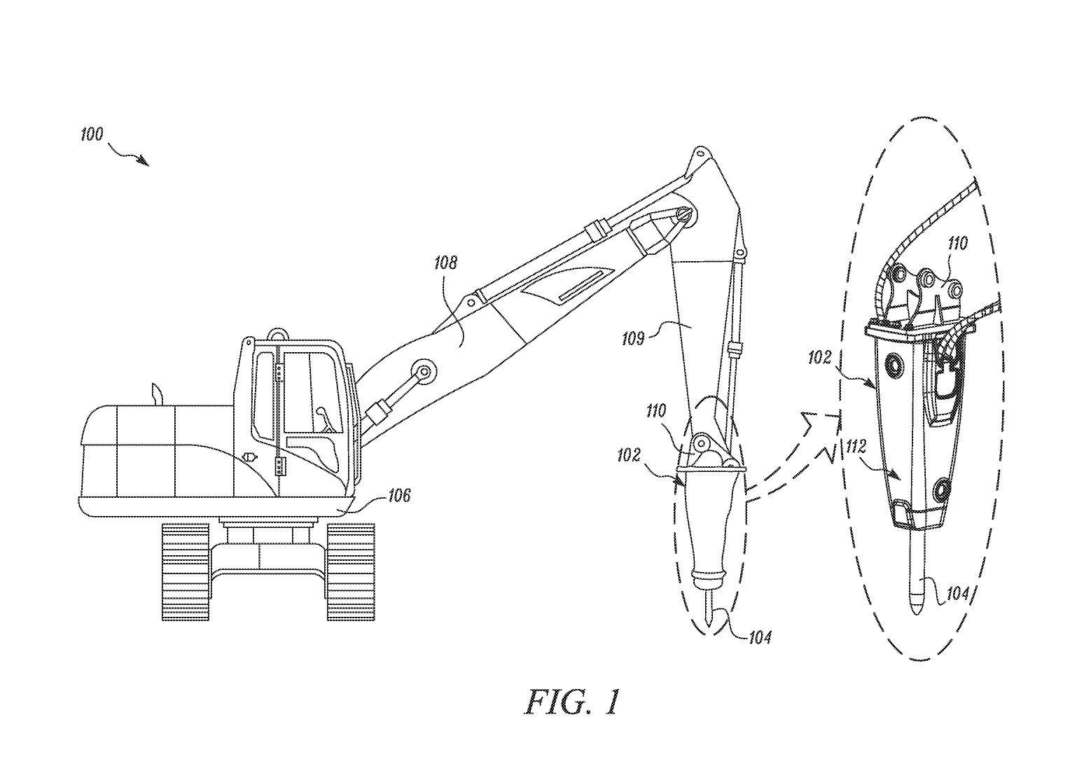

FIG. 1 shows a diagrammatic view of an exemplary machine 100. The machine employs a hydraulic hammer 102 shown in accordance with an embodiment of the present disclosure. The hydraulic hammer 102 includes a pecking tool 104 that is configured to break rocks and drill ground surfaces.

In the illustrated embodiment of FIG. 1, the machine 100 is embodied in the form of a tracked industrial vehicle such as an excavator, wherein the hydraulic hammer 102 is mounted to replace an excavator bucket (not shown) previously associated with the excavator. Consequently, the hydraulic hammer 102 is operated by the excavator's hydraulics. However, it may be contemplated to use other types of machines and carriers to power the hydraulic hammer 102 of the present disclosure.

As shown in FIG. 1, the machine 100 includes a frame 106; one or more linkages 108, 109; and a pivoting bracket 110 that pivotally connects the hydraulic hammer 102 to the linkage 109. The linkages 108, 109 may be articulated relative to the frame 106 in order to change an orientation and/or position of the hydraulic hammer 102 with respect to a ground surface.

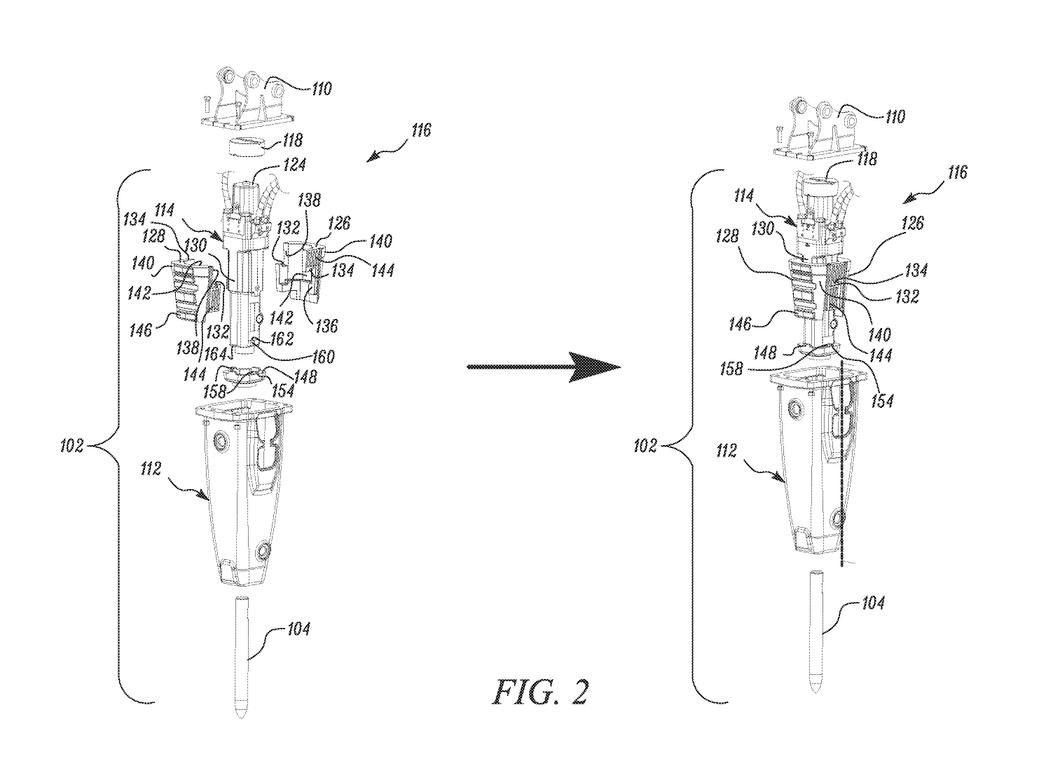

Referring to FIG. 2, a diagrammatic view of the hydraulic hammer 102 is rendered showing the hydraulic hammer 102 in an exploded configuration and an assembled configuration respectively. The hydraulic hammer 102 includes a body 112 configured to house a power cell 114 therein. The power cell 114 is configured to drive the pecking tool 104 of the hydraulic hammer 102 so that the pecking tool 104 may perform functions that are consistent with the present disclosure. The present disclosure relates to a damper system 116 that is provided to the power cell 114 of the hydraulic hammer 102.

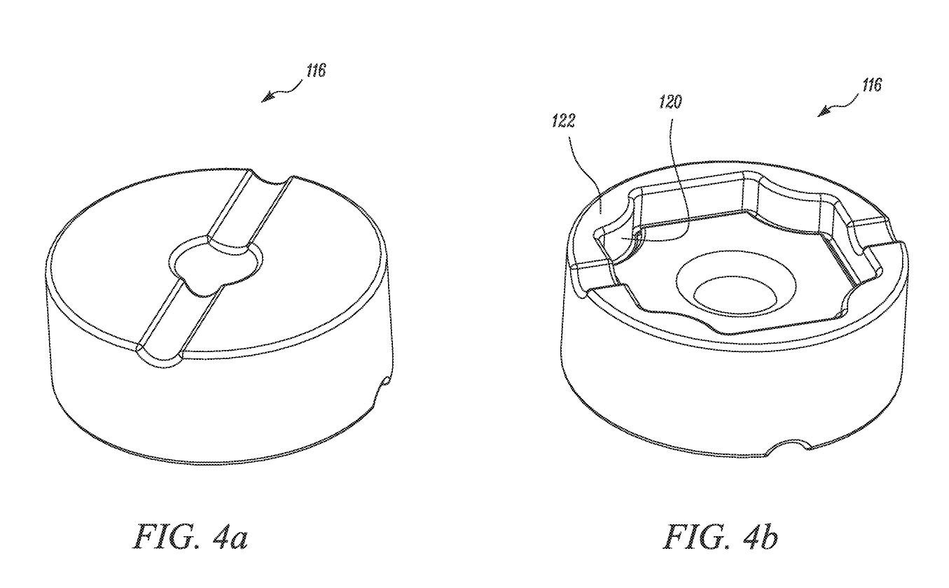

Referring to FIGS. 2, 3, and 4a, the damper system 116 includes a single-piece top damper 118 element that is configured to be disposed on the power cell 114. Referring to FIGS. 2 and 4b, the single-piece top damper 118 element may include co-operating structures 120 defined at a bottom side 122 thereof. Such co-operating structures 120 may be configured to releasably engage with a top portion 124 of the power cell 114.

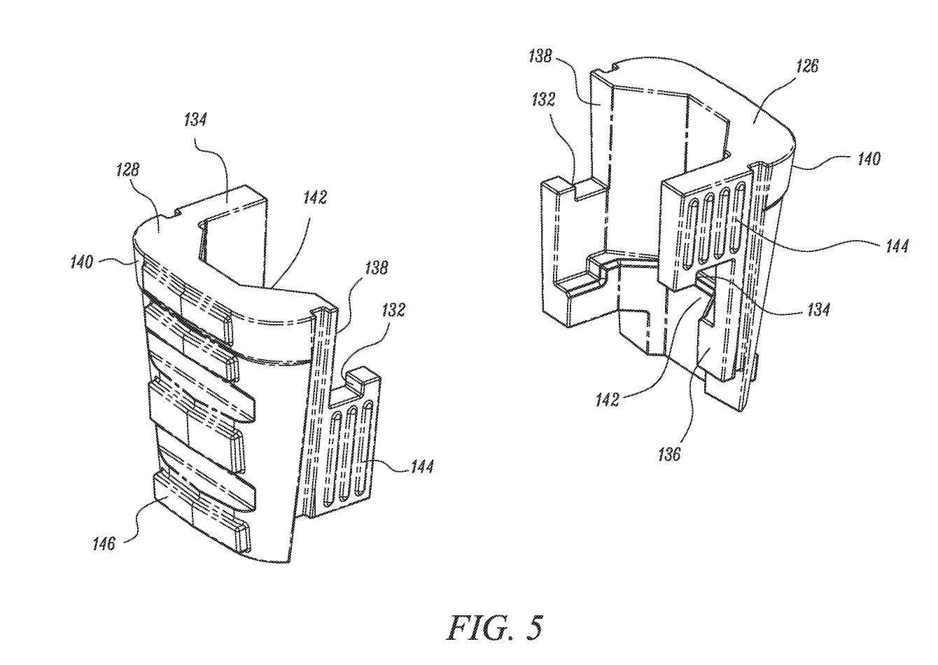

Referring to FIGS. 2, 3, and 5, the damper system 116 further includes a pair of middle damper elements 126, 128. The pair of middle damper elements 126, 128 is disposed about a mid-portion 130 of the power cell 114. As shown in FIG. 5, the pair of middle damper elements 126, 128 is mutually identical in construction. With such identical configuration of the middle damper elements 126, 128, manufacturers may be able to easily produce several pieces of such identically configured middle damper elements 126, 128 using the same machinery and/or tooling equipment as would be required to produce any one of the middle damper elements 126, 128. Hence, with implementation of such identical configurations of the middle damper elements 126, 128, manufacturers can now offset costs that were previously associated with producing dampers of unique configurations. It may be noted that the term ‘configuration/s’ disclosed herein in conjunction with the middle dampers refers to a shape and/or size of the middle damper elements 126, 128.

Moreover, as shown in FIGS. 2, 3, and 5, each of the middle damper elements 126, 128 includes interlocking features 132, 134 at lateral ends 136, 138 thereof The interlocking features 132, 134 are configured to allow a releasable engagement of the middle damper elements 126, 128.

In the illustrated embodiments of FIGS. 2, 3, and 5, each of the middle dampers includes an outer surface 140 and an inner surface 142. The outer surface 140 is configured to face the body 112 of the hydraulic hammer 102, while the inner surface 142 is configured to face the power cell 114. As shown, the outer surface 140 defines a plurality of longitudinally and laterally oriented ridges 144, 146. These ridges 144, 146 are configured to facilitate gripping of the middle damper elements 126, 128 by the body 112 of the hydraulic hammer 102.

Although ridges 144, 146 are shown bulging outward from the outer surface 140 of each middle damper in the depicted embodiments of FIGS. 2 and 5, one of ordinary skill in the art can contemplate other structures or modifications to a contour of the outer surface 140 and accomplish the gripping of the middle damper elements 126, 128 by the body 112 of the hydraulic hammer 102. Additionally or optionally, one can also contemplate to beneficially provide such ridges 144, 146 on the inner surface 142 of each middle damper element 126, 128 so that an improved gripping of the middle damper elements 126, 128 by power cell 114 may be accomplished upon fitment thereto.

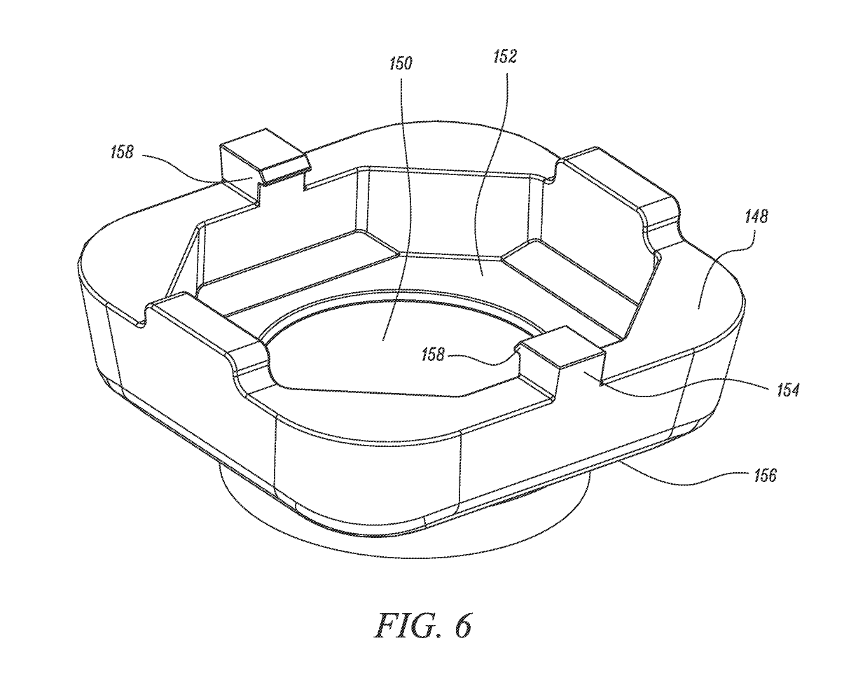

Referring to FIGS. 2, 3, and 6, the damper system 116 further includes a single-piece bottom damper element 148. The bottom damper element 148 is formed from a material having a Shore hardness in the range of about 90 A to 95 A. One example of suitable material may be Polyester urethane of Shore hardness 90 A to 95 A. It is hereby envisioned that the Shore hardness of 90 A to 95 A is adequate to bear a weight of the power cell 114 thereon while also the withstanding forces encountered during operation of the hydraulic hammer 102. Moreover, it is envisioned that the Shore hardness of about 90 A to 95 A may also be adequate to absorb the vibrations and/or attenuate noise typically experienced during the operation of the hydraulic hammer 102.

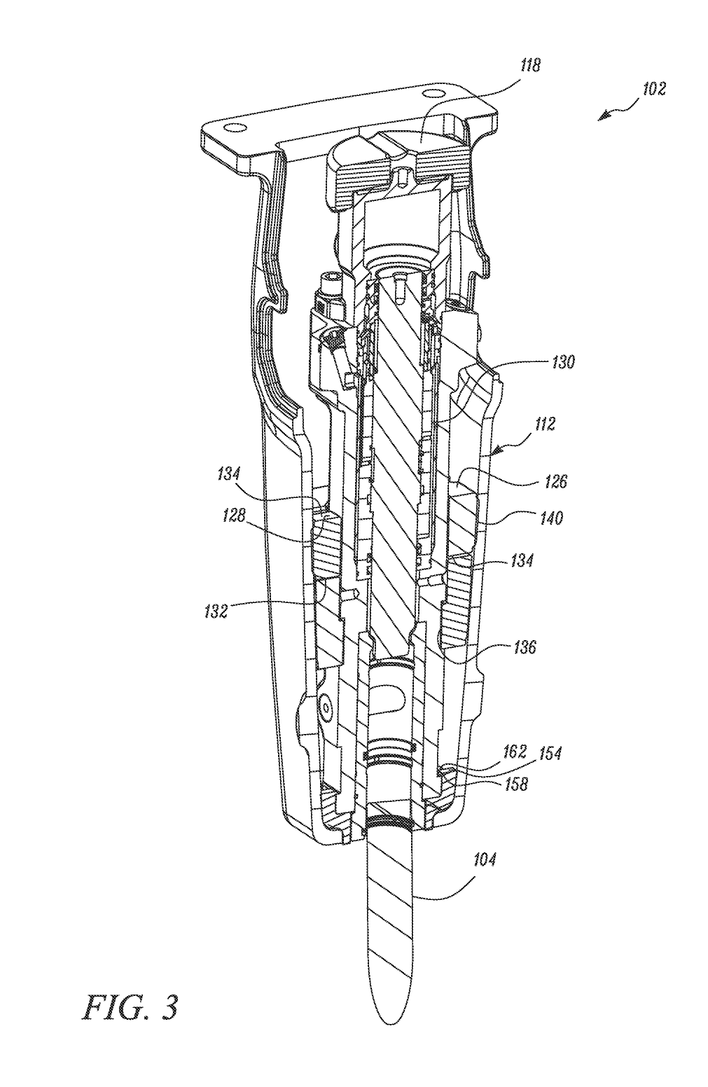

With continued reference to FIGS. 2, 3, and 6, the bottom damper element 148 defines a central opening 150 therein. The central opening 150 is configured to allow passage of the pecking tool 104 therethrough (See FIG. 3). The bottom damper element 148 includes a base plate 152, and a plurality of appendages 154. The base plate 152 is disposed about the central opening 150 and is configured to bear the power cell 114 thereon. The appendages 154 extend axially upwards from a periphery 156 of the base plate 152 and are disposed about the central opening 150.

The bottom damper element 148 further includes a lateral projection 158 extending radially inward from each of the plurality of appendages 154. As best shown in FIGS. 2 and 3, the lateral projection 158 is configured to abut a top side 162 of a keel member 160 defined at a bottom portion 164 of the power cell 114.

Various embodiments disclosed herein are to be taken in the illustrative and explanatory sense, and should in no way be construed as unduly limiting of the present disclosure. All directional references (e.g., above, below, upper, lower, top, bottom, vertical, horizontal, inward, outward, radial, upward, downward, left, right, leftward, rightward, clockwise, and counter-clockwise) are only used for identification purposes to aid the reader's understanding of the present disclosure, and may not create limitations, particularly as to the position, orientation, or use of the systems and/or methods disclosed herein. Joinder references (e.g., attached, affixed, coupled, engaged, connected, and the like) are to be construed broadly. Moreover, such joinder references do not necessarily infer that two elements are directly connected to each other.

Additionally, all numerical terms, such as, but not limited to, “first”, “second”, “third”, or any other ordinary and/or numerical terms, should also be taken only as identifiers, to assist the reader's understanding of the various embodiments, variations, components, and/or modifications of the present disclosure, and may not create any limitations, particularly as to the order, or preference, of any embodiment, variation, component and/or modification relative to, or over, another embodiment, variation, component and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The damper system 116 of the present disclosure has applicability in damping vibrations and attenuating noise experienced during operation of the hydraulic hammer 102.

In an aspect of the present disclosure, the interlocking features 132, 134 provided to the middle damper elements 126, 128 allow a releasable yet secure joint to be established between the middle damper elements 126, 128. Moreover, the ridges 144, 146 provided to the outer surface 140 of the middle damper elements 126, 128 assists the middle damper elements 126, 128 in being gripped by the body 112 of the hydraulic hammer 102.

Further, with identical configuration of the middle damper elements 126, 128, manufacturers of the present damper system 116 may produce the middle damper elements 126, 128 easily and quickly using a single type of tooling and/or manufacturing equipment. Consequently, manufacturers can offset costs previously incurred in the production of uniquely configured damper elements.

Furthermore, as the bottom damper element 148 is made from materials having specific grades or ranges of Shore hardness, in this case 90 A to 95 A, it is envisioned that the bottom damper element 148 may be imparted with adequate strength to bear a weight of the power cell 114 and also withstand the forces encountered during operation of the hydraulic hammer 102.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. A damper system for a power cell of a hydraulic hammer, the damper system comprising:
a single-piece top damper element configured to be disposed on the power cell;
a pair of middle damper elements disposed about a mid-portion of the power cell, wherein the pair of middle damper elements are mutually identical in construction, and wherein each of the middle damper elements include interlocking features at lateral ends thereof, the interlocking features are configured to allow a releasable engagement of the middle damper elements; and
a single-piece bottom damper element formed from a material having Shore hardness in the range of about 90 A to 95 A, the single-piece bottom damper element defining a central opening therein, the central opening configured to allow passage of a pecking tool therethrough, wherein the single-piece bottom damper element includes:
a base plate disposed about the central opening, the base plate configured to bear the power cell thereon;
a plurality of appendages extending axially upwards from a periphery of the base plate and disposed about the central opening; and
a lateral projection extending radially inward from each of the plurality of appendages, the lateral projection configured to abut a top side of a keel member defined at a bottom portion of the power cell.
